(19) United States
(12) Patent Application Publication
(10) Pub. No.: US 2014/0262960 A1
(43) Pub. Date: Sep. 18, 2014

(54) SOLVENT RECOVERY SYSTEM BELOW SUPERCRITICAL CONDITIONS

(71) Applicant: PetroSonic Energy Inc., Calgary (CA)

(72) Inventors: Art AGOLLI, Calgary (CA); Patrick Brunelle, Langdon (CA); Alfred Fischer, Calgary (CA)

(73) Assignee: PetroSonic Energy Inc., Calgary (CA)

(21) Appl. No.: 14/208,693

(22) Filed: Mar. 13, 2014

Related U.S. Application Data
(60) Provisional application No. 61/789,963, filed on Mar. 15, 2013.

(51) Int. Cl. C10G 32/00; B01J 19/10

(52) U.S. Cl. CPC C10G 32/00; B01J 19/10
USPC 208/309; 422/127

(57) ABSTRACT

A system and process for solvent recovery after sonic treatment of heavy oil feedstocks is disclosed. The system avoids supercritical variations. The separation process involves solvent selection and use of a proprietary sonic reactor. The solvent recovery process may include pressure variations to solvent materials in order to obtain separation from of solvents from separated asphaltenes or deasphalted oil at high temperatures. The applied pressure variations allow the separation to occur avoiding supecritical states in the solvent materials.

### CROSS REFERENCE TO RELATED APPLICATIONS

This application claims priority to U.S. Provisional Patent Application Ser. No. 61/789,963, filed Mar. 15, 2013, entitled “Solvent Recovery System Below Supercritical Conditions,” which is hereby incorporated by reference in its entirety.

### BACKGROUND

1. Field of the Disclosure

The present disclosure relates generally to treatment of heavy oil feedstocks and more particularly, to a system and process for solvent recovery after asphaltenes separation of heavy oil using sonic treatment.

2. Background Information

With the depletion of conventional crude oil reserves in the world, heavy oil and bitumen resources appear to have great potential to meet the future demand for petroleum products. Heavy oil typically contains a much higher concentration of asphaltenes compared to conventional crude oil. Asphaltenes create high viscosity on crude oils, complicating the production process of heavy oils. Removal of asphaltenes from heavy oil feedstocks may be done by using solvents mixed together with the heavy crude oil (HCO). Due to high prices, the recovery of solvents used for the asphaltene removal becomes a critical step in the production process.

Recovery for solvents in asphaltene removal from heavy oil may be done by using supercritical phase, where the temperature may be raised in order to allow the solvents to evaporate and separate themselves from the de-asphalted oil. In a supercritical stage there is a higher risk for explosions and due to the gas state of the solvents more pressure control is needed. The need to address these issues in supercritical stage significantly increases the cost of solvent recovery.

Thus, a need exists for a process for solvent recovery avoiding supercritical conditions.

### SUMMARY

The present disclosure provides a method for solvent recovery in heavy crude oil upgrading systems.

The system may include a method of heavy oil feedstock upgrading by separation of asphaltenes, sulfur, and heavy metals through a sonication process in order to reduce viscosity, allow for easier transportation and remove asphaltenes.

The system may allow high yields of solvent recovery at a lower cost compared to conventional methods. The method may allow solvent recovery by conventional methods such as distillation by avoiding supercritical conditions. The method may allow separation of solvent materials from deasphalted oil and asphaltenes at high temperatures but avoiding the flashpoint of the materials by applying pressure. The pressure may be calculated depending on the solvent material used and the temperatures desired. The temperatures may vary depending on the desired percentage of solvent recovery.

The system and process of solvent and asphaltene separation post sonication may provide recovery results in a range of about 85% to 92%, leaving a solvent residual in the oil within a range of about 4% to about less than 2%. This solvent residual in the oil may be within the expected quality parameters for pipeline transportation and refinery specifications. The solvent recovered may be reused and recycled with added new solvent for the continuous process of production of DAO and removal of asphaltenes and residues.

In one embodiment, a method for separating solvents and asphaltenes comprises: combining heavy oil feedstock with a solvent to form a mixture; performing sonication on the mixture using a sonic reactor to separate deasphalted oil including the a first portion of the solvent from asphaltenes including a second portion of the solvent; processing the deasphalted oil including the first portion of the solvent to recover the solvent from the deasphalted oil; and processing the asphaltenes including the second portion of the solvent to recover the solvent from the asphaltenes, wherein processing the asphaltenes including the second portion of the solvent to recover the solvent from the asphaltenes comprises: applying pressure to the asphaltenes and the second portion of the solvent; and heating the second portion of the solvent and the asphaltenes to a temperature from 100° C. and about 300° C. such that the asphaltenes do not boil.

In another embodiment, a method for separating solvents and asphaltenes comprises: combining heavy oil feedstock with a solvent to form a mixture; performing sonication on the mixture using a sonic reactor to separate deasphalted oil including the a first portion of the solvent from asphaltenes including a second portion of the solvent; processing the deasphalted oil including the first portion of the solvent to recover the solvent from the deasphalted oil; processing the asphaltenes including the second portion of the solvent to recover the solvent from the asphaltenes, wherein processing the asphaltenes including the second portion of the solvent to recover the solvent from the asphaltenes comprises: applying pressure to the asphaltenes and the solvent; and heating the second portion of the solvent and the asphaltenes to a temperature from 100° C. and about 300° C. such that the asphaltenes do not boil; collecting the solvent recovered from the deasphalted oil and the asphaltenes; and combining a second batch of heavy oil feedstock with the recovered solvent.

In another embodiment, a solvent and asphaltene separation system comprises: an in-line mixer configured to receive heavy oil feedstock and solvent and mix the heavy oil feedstock and solvent to form a homogeneous mixture; a sonicator connected to the in-line mixer and configured to receive the homogeneous mixture from the in-line mixer and apply a low-frequency, high-amplitude, high-vibrational energy to the homogeneous mixture to separate deasphalted oil including a first portion of the solvent from asphaltenes including a second portion of the solvent; a splitter configured to receive the separated deasphalted oil including the first portion of the solvent from asphaltenes including the second portion of the solvent, direct the deasphalted oil including the first portion of the solvent to a first feedline, and direct the asphaltenes including the second portion of the solvent to a second feedline; a heat separator vessel connected to the second feedline and configured to receive the asphaltenes including the second portion of the solvent and separate the asphaltenes from the second portion of the solvent by causing the solvent to evaporate by heating the asphaltenes including the second portion to a temperature from 100° C. and about 300° C. such that the asphaltenes do not boil, wherein pressure is applied to the asphaltenes and the second portion of the solvent while heating the asphaltenes and the second portion of the solvent; and a separator connected to the first feedline and configured to receive the deasphalted oil including the first portion of the solvent and separate the deasphalted oil from the solvent.

Numerous other aspects, features of the present disclosure may be made apparent from the following detailed description, taken together with the drawing figures.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 is a system for solvent and asphaltenes separation after sonication, according to an embodiment of present disclosure.

FIG. 2A depicts an isometric view of a sonicator used in upgrading heavy oil feedstocks, according to an embodiment of present disclosure.

FIG. 2B depicts a front view of a sonicator used in upgrading heavy oil feedstock, according to an embodiment of present disclosure.

FIG. 2C depicts a sectional view of a sonicator, according to an embodiment of present disclosure.

FIG. 2D depicts a second sectional view of a sonicator, according to an embodiment of present disclosure.

### DETAILED DESCRIPTION

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or other changes may be made without departing from the spirit or scope of present disclosure.

### DEFINITIONS

As used herein, the following terms may have the following definitions:

“Sonication” may refer to any device or system which produces vibrational energy sufficient to impact one or more desired end uses.

“Asphaltenes” may refer to materials, present in heavy oils and bitumen's, which precipitate in n-alkanes solvent.

“Bitumen” may refer to a sticky, black and highly viscous liquid or semi-solid form of petroleum, Also known as asphalt. It may be found in natural deposits or may be a refined product.

### DESCRIPTION OF THE DRAWINGS

Solvent and Asphaltenes Separation System

FIG. 1 is a system diagram for separation process 100 where solvent separation after sonication may be achieved for both deasphalted oil (DAO) and from the asphaltenes separated, according to present disclosure.

The separation process 100 for heavy oil may be directly processed for the removal of asphaltenes, sulfur and heavy metals onsite of the heavy oil feedstock reservoir 102 in order to facilitate transportation.

An inline mixer 104 may be used in order to mix the solvent with the heavy oil before the sonication process. The mix heavy oil/solvent may then be fed into a chamber in a proprietary sonic reactor 106. Sonic reactor 106 may then resonate at a frequency between 110 hertz and 90 hertz. The residence time of the heavy oil in Sonic reactor 106 may be between 5 seconds up to 2 minutes. The output from sonic reactor 106 may then be directed to a splitter 108 from where the separated materials may be directed into different processing to obtain the desired solvent and asphaltene separation post sonication. The distance of feedline 110 between Sonic reactor 106 and splitter 108 may be critical to prevent hardening of separated asphaltenes which may clog feedline 110. Split materials, DAO and solvent may flow through DAO-solvent feedline 112, and solvent-saturated asphaltenes, residues, and heavy metals may flow through asphaltene-solvent feedline 114 after having sedimented at the bottom of splitter 108.

The solvent-saturated asphaltenes, residues and heavy metals in asphaltene-solvent feedline 114 may be subsequently fed to heater 116 where limited temperature within the range of about 100° C. and about 300° C. may be applied without reaching the boiling point of any of the volatile materials. An increase in the pressure of the asphaltene/solvent may allow for an increase in the temperature. The required pressure may be calculated from the physical properties of the solvent with data available from sources such as the NIST Standard Reference Database. For mixture of solvents, softwares such as HYSYS or VMGSim can be used to calculate the required pressure required at a certain temperature.

The pressure may vary depending on the solvent material used and the temperature desired. From heater 116 solvent-saturated asphaltenes, residues and heavy metals may be sent to asphaltene separator vessel 118 which may include load control 120 and flow valve 122. Asphaltene separator vessel 118 may dry up extra DAO and solvent which may be fed to DAO-solvent feedline 112, and asphaltenes, residues, and heavy metals may drop at the bottom from where they are fed into heat exchanger 124 for cooling, adjusting temperature from about 250° C. to 150° C. and subsequent storing into a storage (not shown) an end product asphalthene 126. Asphalthene 126 may be taken for processing into emulsification equipment (not shown) for conversion into fuel or made available for selling in asphalt markets. Composition of materials that may drop at bottom of asphaltene separator vessel 118 may be 95% asphaltene.

The solvent-DAO on DAO-solvent feedline 112 is fed to heater 128 which may subsequently send DAO and solvent to DAO separator vessel 130, which may be pressure vessels, or vacuum amongst others that may achieve high level of separation between the DAO and the solvent.

The temperature desired may be determined by the solvent material used and by the desired percentage of return.

Different quantities of DAO and solvent may be obtained in DAO separator vessel 130. The quantities and qualities that may be obtained depend on the size of DAO separator vessel 130 and the steps of separation that may be involved. Low molecular weight solvent recovered during processing in DAO separator vessel 130 may be sent to heat exchanger 132 for cooling and then sent to solvent cleanup vessel 134. Additionally, aromatic, paraffinic, or high molecular weight solvent that may be recovered at the bottom of solvent cleanup vessel 134 may be added to the DAO extracted from DAO separator vessel 130.

Output solvent from solvent cleanup vessel 134 may be fed to heat exchanger 136 for a second cooling stage before it may be sent to solvent tank 138, where load control 140 and flow valve 142 may act to supply about 10% makeup solvent 144 volume that may be added from a solvent storage tank (not shown) to the solvent recovered to maintain the volume and solvent ratio that may be required to continue processing heavy oil feedstock in separation process 100.

Separated DAO 146 may be stored, or sent to other refineries for additional processing or used for commercial purposes.

FIG. 2 is a series of views of Sonic Reactor 106 that may be used in separation process 100. FIG. 2A shows 3D View 202, FIG. 2B shows front view 204, FIG. 2C shows right plane section 206, and FIG. 2D shows front plane section 208. Sonic Reactor 106 is shown having support structure 210, resonant bar 212, and a set of magnet configuration 214, resonant bar supports 216, and reaction chamber 218 on each end of resonant bar 212.

Sonic reactor 106 may use support structure 210 to hold resonant bar 212 in place using any suitable support as resonant bar supports 216. Suitable configurations for resonant bar supports 216 may include configurations including three or more rubber air cushions. Any suitable magnet configuration 214, activated by a control module (not shown), may cause resonant bar 212 to vibrate, sonicating HOF in one or more reaction chambers 218. Suitable configurations for magnet configuration 214 include configurations with at least 3 magnets and power suitable to cause resonant bar 212 to vibrate.

HOF in reaction chamber 218 may have previously been chemically altered to allow the upgrading of HFO in reaction chamber 218, methods for preparing it for such including the addition of one or more solvents.

The period of time needed to upgrade HOF in reaction chamber 218 may vary in dependence with a number of factors, including the amplitude and frequency of the vibration of resonant bar 212.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

The embodiments described above are intended to be exemplary. One skilled in the art recognizes that numerous alternative components and embodiments that may be substituted for the particular examples described herein and still fall within the scope of the invention.

What is claimed is:

1. A method for separating solvents and asphaltenes comprising:
combining heavy oil feedstock with a solvent to form a mixture;
performing sonication on the mixture using a sonic reactor to separate deasphalted oil including the a first portion of the solvent from asphaltenes including a second portion of the solvent;
processing the deasphalted oil including the first portion of the solvent to recover the solvent from the deasphalted oil; and
processing the asphaltenes including the second portion of the solvent to recover the solvent from the asphaltenes, wherein processing the asphaltenes including the second portion of the solvent to recover the solvent from the asphaltenes comprises:
applying pressure to the asphaltenes and the second portion of the solvent; and
heating the second portion of the solvent and the asphaltenes to a temperature from 100° C. and about 300° C. such that the asphaltenes do not boil.

2. The method of claim 1, wherein an amount of pressure applied to the asphaltenes and the solvent is calculated based on the physical properties of the solvent.

3. The method of claim 1, wherein the pressure depends on the temperature applied to the asphaltenes and the solvent.

4. The method of claim 1, wherein an amount of solvent mixed with the heavy oil feedstock maintains a predetermined ratio with the heavy oil feedstock based on the level of chemicals contained in the heavy oil feedstock, a designated level of separation of asphaltenes, cost factors associated with the separation process, and market demands.

5. The method of claim 1, wherein the sonication is performed for 5 seconds to 2 minutes based on the solvent and the heavy oil feedstock included in the mixture.

6. The method of claim 1, wherein sonication applies a low-frequency, high-amplitude, and high-vibrational energy to the mixture.

7. The method of claim 1, wherein processing the deasphalted oil including the first portion of the solvent to recover the solvent from the deasphalted oil comprises:
applying pressure to the deasphalted oil including the solvent; and
heating the solvent and the deasphalted oil to a temperature based on the boiling point of the solvent.

8. A method for separating solvents and asphaltenes comprising:
combining heavy oil feedstock with a solvent to form a mixture;
performing sonication on the mixture using a sonic reactor to separate deasphalted oil including the a first portion of the solvent from asphaltenes including a second portion of the solvent;
processing the deasphalted oil including the first portion of the solvent to recover the solvent from the deasphalted oil;
processing the asphaltenes including the second portion of the solvent to recover the solvent from the asphaltenes, wherein processing the asphaltenes including the second portion of the solvent to recover the solvent from the asphaltenes comprises:
applying pressure to the asphaltenes and the solvent; and
heating the second portion of the solvent and the asphaltenes to a temperature from 100° C. and about 300° C. such that the asphaltenes do not boil;
collecting the solvent recovered from the deasphalted oil and the asphaltenes; and
combining a second batch of heavy oil feedstock with the recovered solvent.

9. The method of claim 8, wherein an amount of pressure applied to the asphaltenes and the solvent is calculated based on the physical properties of the solvent.

10. The method of claim 8, wherein the pressure depends on the temperature applied to the asphaltenes and the solvent.

11. The method of claim 8, wherein an amount of solvent mixed with the heavy oil feedstock maintains a predetermined ratio with the heavy oil feedstock based on the level of chemicals contained in the heavy oil feedstock, a designated level of separation of asphaltenes, cost factors associated with the separation process, and market demands.

12. The method of claim 8, wherein the sonication is performed for 5 seconds to 2 minutes based on the solvent and the heavy oil feedstock included in the mixture.

13. The method of claim 8, wherein sonication applies a low-frequency, high-amplitude, and high-vibrational energy to the mixture.

14. The method of claim 8, wherein processing the deasphalted oil including the first portion of the solvent to recover the solvent from the deasphalted oil comprises:
applying pressure to the deasphalted oil including the solvent; and
heating the solvent and the deasphalted oil to a temperature based on the boiling point of the solvent.

15. A solvent and asphaltene separation system comprising:
an in-line mixer configured to receive heavy oil feedstock and solvent and mix the heavy oil feedstock and solvent to form a homogeneous mixture;
a sonicator connected to the in-line mixer and configured to receive the homogeneous mixture from the in-line mixer and apply a low-frequency, high-amplitude, high-vibrational energy to the homogeneous mixture to separate deasphalted oil including a first portion of the solvent from asphaltenes including a second portion of the solvent;
a splitter configured to receive the separated deasphalted oil including the first portion of the solvent from asphaltenes including the second portion of the solvent, direct the deasphalted oil including the first portion of the solvent to a first feedline, and direct the asphaltenes including the second portion of the solvent to a second feedline;
a heat separator vessel connected to the second feedline and configured to receive the asphaltenes including the second portion of the solvent and separate the asphaltenes from the second portion of the solvent by causing the solvent to evaporate by heating the asphaltenes including the second portion to a temperature from 100° C. and about 300° C. such that the asphaltenes do not boil, wherein pressure is applied to the asphaltenes and the second portion of the solvent while heating the asphaltenes and the second portion of the solvent; and
a separator connected to the first feedline and configured to receive the deasphalted oil including the first portion of the solvent and separate the deasphalted oil from the solvent.

16. The solvent and asphaltene separation system of claim 15, further comprising:
a heat exchanger connected to the heat separator vessel and configured to cool the asphaltenes.

17. The solvent and asphaltene separation system of claim 15, wherein the separator is a two-stage separator comprising:
a flash drum performing the first stage; and
a vacuum or steam distillation performing the second step.

18. The solvent and asphaltene separation system of claim 15, further comprising:
a solvent cleanup vessel connected to the heat separator vessel and the separator and configured to clean the solvent before the solvent is recycled.

19. The solvent and asphaltene separation system of claim 19, further comprising:
a solvent staging area configured to receive recycled solvent from the solvent cleanup vessel, receive additional solvent from a solvent storage tank to maintain a predetermined solvent to heavy oil feedstock ratio, and provide solvent to the in-line mixer.
